(19) United States
(12) Patent Application Publication
(10) Pub. No.: US 2012/0229087 A1
(43) Pub. Date: Sep. 13, 2012

(54) AUTOMOBILE WITH ELECTRIC DRIVE AND BATTERY, AND METHOD FOR OPERATING A DEVICE FOR CHARGING A BATTERY

(75) Inventor: Wolfgang Demmelbauer-Ebner, Neusiedl am See (AT)

(73) Assignee: AUDI HUNGARIA MOTOR Kft., Gyor (HU)

(21) Appl. No.: 13/228,616

(22) Filed: Sep. 9, 2011

(30) Foreign Application Priority Data
Sep. 10, 2010 (DE) 10 2010 045 032.4

(51) Int. Cl. H02J 7/00

(52) U.S. Cl. 320/109

(57) ABSTRACT

In an automobile with an electric drive, the battery for powering the electric drive must be charged, wherein a device for charging is associated with the automobile. According to the invention, this device is activated and/or deactivated upon demand both during travel of the automobile and when the automobile is at rest. The demand is hereby determined based on a specified route to be traveled in the future.

### CROSS-REFERENCES TO RELATED APPLICATIONS

This application claims the priority of German Patent Application, Serial No. 10 2010 045 032.4, filed Sep. 10, 2010, pursuant to 35 U.S.C. 119(a)-(d), the content of which is incorporated herein by reference in its entirety as if fully set forth herein.

### BACKGROUND OF THE INVENTION

The present invention relates to an automobile with an electric drive and a battery for supplying electric current to this electric drive. The automobile includes a device for charging the battery, wherein the device for charging is different from the electric drive, with a controller controlling the device for charging. The device also includes a method for operating such device for charging a battery in an automobile with an electric drive.

The following discussion of related art is provided to assist the reader in understanding the advantages of the invention, and is not to be construed as an admission that this related art is prior art to this invention.

Preferably, a power generation unit is provided as a device for charging, which includes an internal combustion engine driving a generator. This is also referred to as a “range extender.” A study of the Audi A1 E-tron was demonstrated by the applicant at the Geneva Auto Show where the rechargeable lithium ion battery weighing 150 kg is installed in the subfloor as a battery. In particular, the internal combustion engine is implemented as a Wankel engine. Alternatively, a fuel-cell can also be used as a range extender which first extracts hydrogen from fuel, such as gasoline, and then converts the hydrogen.

It should be avoided that the range extender is started up too late, resulting in more current to be consumed than can concurrently be provided by the range extender. It is therefore part of an optimal charging strategy to timely turn on or switch in the range extender so as to adequately charge the electric battery.

It is an object of the present invention to charge the battery (or generally an energy store) associated with an automobile with an electric drive under the most optimal conditions, without having a range extender operate excessively and hence unnecessarily consume fuel.

It would therefore be desirable and advantageous to obviate prior art shortcomings and to provide an improved automobile with an electric drive, wherein the battery (or generally an energy store) associated with the automobile can be charged under most optimal conditions, without having a range extender operate excessively and hence unnecessarily consume fuel.

### SUMMARY OF THE INVENTION

According to one aspect of the present invention, an automobile includes an electric drive driving the automobile, a battery supplying electric current to the electric drive, a charging device for charging the battery, wherein the charging device is a part of the automobile and different from the electric drive, and a controller controlling the charging device, wherein the controller activates and/or deactivates the charging device on demand both while the automobile travels and while the automobile is at rest, wherein the demand is determined based on a route traveled in the future, said route being determined by at least one predetermined criterion.

The terms “activating” and “deactivating” refer in the present context to the startup for the purpose of actually charging and the shut-off for terminating this charging.

The charging strategy is thus not or not exclusively dependent on pure measurement values relating to an actual situation, but charging is performed forward-looking. Charging while the automobile is at rest has the advantage that the charge state of the battery is adequate already at the beginning of the trip, so that the trip can take place on the route to be traveled in the future.

According to an advantageous feature of the present invention, the controller is coupled with a navigation device of the automobile for receiving from the navigation device destination data and/or route data. Destination data are data defining the destination of a trip, or an intermediate destination. If these data are available to the navigation device, then the route traveled in the future can be conclusively determined. Route data are particularly those data that are obtained during travel of the automobile and which provide information about the traveled route. In the simplest case, the route data are those data which define the position of the automobile at predetermined times. Using data from the navigation device has the advantage that the operator is not required to separately input data for planning the charging process; the navigation device is typically used under all circumstances.

According to another advantageous feature of the present invention, the controller may be coupled with a device for receiving data from a data processing device external of the vehicle, in particular for receiving these data from the receiving device and for determining therefrom the route traveled in the future.

According to yet another advantageous feature of the present invention, data of the route traveled in the future or at least data of the destination may be transmitted to the automobile externally. However, only data for time planning may be transmitted to the automobile—in particular from an electronic calendar, with the controller then having supplementary data available. For example, it may be evident from the calendar that an operator wishes to travel to his workplace in the morning and home in the evening, wherein the workplace is then stored in the navigation device of the automobile as a destination, as well as the home address.

According to another aspect of the invention, in a method according to the invention for operating a device for charging a battery in an automobile, which supplies electric current to an electric drive which is different from the device for charging, the device for charging is activated and/or deactivated according to demand, wherein the demand is determined based on a route of the automobile traveled in the future, with the route being determined by at least one predetermined criterion.

The advantages recited above with respect to the automobile according to the invention likewise apply to the method according to the invention.

According to an advantageous feature of the present invention, the route may be determined based on an actual destination or a destination that was valid in the past, which was stored in a navigation device of the automobile. A conclusion relating to the route traveled in the future can be easily made based on the destination. Of particular importance is the distance from the present location of the automobile to the destination, which determines the quantity of electric energy to be provided by the battery. Depending on the current charge state of the battery, the controller of the automobile can then compute the amount of charge that must still be supplied to the battery by the device for charging in addition to the existing charge.

According to another advantageous feature of the present invention, the planning data stored in the data processing device relating to a time planning of the operator of the automobile may be taken into account when determining the demand.

For example, the device for charging can already be started up before beginning the trip, so that an adequate charge state is available at the beginning of the trip. The start time of the trip can be determined based on the time planning. In the simplest case, times and locations at these times are listed in an electronic calendar, where the vehicle operator then intends to be or to which the operator wishes to travel starting at a certain time (destinations).

According to still another advantageous feature of the present invention, the data processing device may be provided separate from the automobile and the planning data are transferred, in particular wirelessly, to the automobile.

Such planning data from an electronic calendar are available, in particular in mobile devices such as mobile telephones and palmtops, sometimes also in laptops, which the vehicle operator carries with him anyway and therefore also transports to and into the automobile. Transfer is then possible without difficulty. In a preferred embodiment, such planning data therefore need no longer be inputted directly into a device of the automobile; however, this world alternatively also be possible, or conceivable, if the automobile assumes additional functions, for example if the automobile is equipped with a type of personal computer whose data are transmitted in the opposite direction to a mobile data device; the planning data may also be transmitted from a central server to which the planning data are regularly transferred from different stationary data processing devices—the electronic calendar is then no longer tied to a certain data processing device.

### BRIEF DESCRIPTION OF THE DRAWING

Other features and advantages of the present invention will be more readily apparent upon reading the following description of currently preferred exemplified embodiments of the invention with reference to the sole figure, in which:

FIG. 1 shows schematically an automobile in which the method according to the present invention can be performed;

### DETAILED DESCRIPTION OF PREFERRED EMBODIMENTS

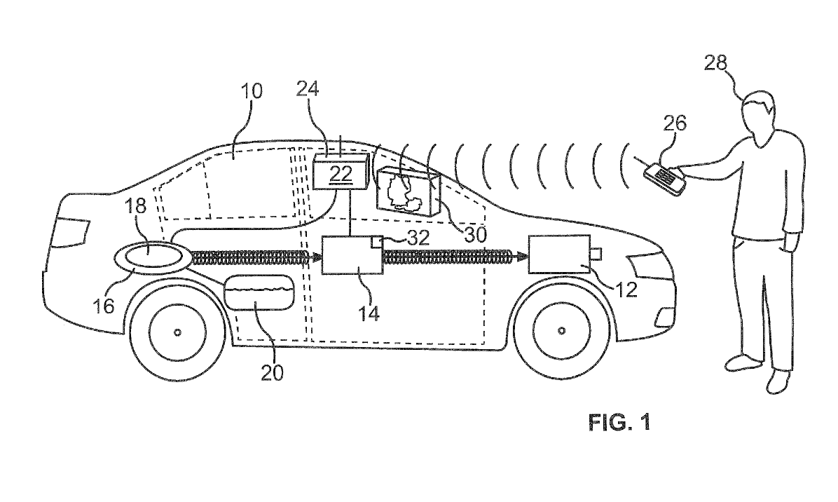

FIG. 1 shows an automobile 10 having an electric drive 12 which is supplied with electric current from an energy store 14, which in the present embodiment is implemented as a lithium ion battery. The battery 14 can be charged from outside the automobile. However, this is not always possible. For this reason, the automobile 10 includes a so-called range extender, namely a Wankel engine 16 coupled with an electric generator 18 which generates electric current for charging the battery 14 during operation of the Wankel engine 16. The Wankel engine 16 is operated with fuel from a fuel tank 20. A controller 22 controls the Wankel engine 16 with the generator 18. The controller 22 is coupled with a receiving device 24 configured to wirelessly receive data from a mobile data processing device, for example a mobile radio telephone 26. In particular, data which provide information about a time and a location of an operator 28 commensurate with the planning by the operator 28 may be transferred from an electronic calendar.

For example, the electronic calendar may show that the person 28 will move at 8 o'clock in the morning to the automobile 10 to drive to work. If the calendar shows, for example, “8 o'clock, drive to work,” then the controller 22 “knows” that this indicates a certain destination. For example, the address of the workplace for the person 28 is shown as designation “work” in the navigation system 30 of the automobile. The controller 22 can then plan how the battery 14 must be charged. The battery may be adequately charged after having been charged in a garage of the person 28. If the electronic calendar now shows “14 o'clock, location B”, then the controller 22 can plan the trip from the workplace to the location B. If the battery 14 is no longer adequately charged after the trip to the workplace, meaning that a trip from the workplace to the location B is not possible without additionally charging the battery, then the Wankel engine 16 is already started before the start of the trip, which should begin around 13:40 o'clock, in the present example thus around 13:25 o'clock, which the controller 22 “knows” from the navigation system 30. By running the Wankel engine 16 exactly for a quarter of an hour, the battery 14 is charged exactly to a point where the trip to the destination B becomes possible exactly or with a sufficient reserve.

If the electronic calendar shows that the person 28 wishes to be at another location C at 15 o'clock, then the Wankel engine can continue to operate already during the trip to B, so that the charge of the battery 14 is likewise sufficient for the trip to the location C shortly thereafter.

The controller 22 then also determines from the electronic calendar that the person 28 wishes to finally travel home. It is not necessary to provide an exact time; instead, the controller 22 will plan to charge the battery 14 so as to ensure an adequate charge of the battery 14 in any case, allowing the trip home from the location C to take place from a certain time on. For example, the battery 14 may be charged for the trip home ahead of time during the trip from location B to location C, or the Wankel engine 16 may be started for half an hour at about 16:30 o'clock to provide the reserve battery charge, if the trip home is anticipated at 17 o'clock at the earliest; the Wankel engine is then turned off at 17 o'clock, regardless if the person 28 starts the trip or not.

The controller 22 thus uses both data that are wirelessly transmitted from an external data processing device 26 and data from the navigation system 30 to plan how the controller 22 needs to operate the Wankel engine 16 in order to charge the battery 14. The charge state of the battery 14 can be known to the controller 22 based on previous charge and discharge operations; however, the charge state is preferably determined by a device 32 for measuring the charge state of the battery 14, with corresponding data being sent to the controller 22.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An automobile comprising:
an electric drive driving the automobile,
a battery supplying electric current to the electric drive,
a charging device for charging the battery, said charging device being a part of the automobile and different from the electric drive, and
a controller controlling the charging device, wherein the controller activates and/or deactivates the charging device on demand both while the automobile travels and while the automobile is at rest, wherein the demand is determined based on a route traveled in the future, said route being determined by at least one predetermined criterion.

2. The automobile of claim 1, wherein the controller is coupled with a navigation device of the automobile for receiving data from the navigation device.

3. The automobile of claim 2, wherein the data received from the navigation device are at least one of destination data and route data.

4. The automobile of claim 1, wherein the controller is coupled with a device receiving data from a data processing device external to the vehicle.

5. A method for operating a charging device for charging a battery in an automobile, with the battery supplying electric current to an electric drive which drives the automobile and is different from the charging device, comprising the step of activating and/or deactivating the charging device upon demand, wherein the demand is determined based on a route traveled in the future, with the route being determined by at least one predetermined criterion.

6. The method of claim 5, wherein the route is determined based on a current destination or a destination that was valid in the past, with the destination stored in a navigation device of the automobile.

7. The method of claim 6, wherein planning data stored in a data processing device relating to time planning by an operator of the automobile are taken into consideration when determining the demand.

8. The method of claim 7, wherein the data processing device is provided separate from the automobile and the planning data are transferred to the automobile.

9. The method of claim 8, wherein the planning data are transferred wirelessly.
